(19) United States
(12) Patent Application Publication
(10) Pub. No.: US 2008/0070482 A1
(43) Pub. Date: Mar. 20, 2008

(54) Composition for Texturing Process

(75) Inventors: Jiro Yamada, Nagano (JP); Megumi Kanda, Aichi (JP); Yoshiki Hayashi, Aichi (JP)

Correspondence Address: SUGHRUE MION, PLLC, 2100 PENNSYLVANIA AVENUE, N.W., SUITE 800, WASHINGTON, DC, 20037, US

(73) Assignees: SHOWA DENKO K.K., TOKYO (JP); YAMAGUCHI SEIKEN KOGYO K.K., AICHI (JP)

(21) Appl. No.: 11/632,295

(22) PCT Filed: Jul. 12, 2005
(86) PCT No.: PCT/JP05/13219

§ 371 Date: Jan. 12, 2007

(30) Foreign Application Priority Data
Jul. 12, 2004 (JP) 2004-204852

(51) Int. Cl. B24B 1/00; C09K 3/14

(52) U.S. Cl. 451/36; 51/304

(57) ABSTRACT

To provide a composition capable of minimizing the average surface roughness (Ra) after texturing of the ground layer of an aluminum magnetic disc or the surface of a glass magnetic disc, forming fine texturing streaks, removing “polishing marks” or “polishing scratches” ascribable to the substrate polishing step and which are present on the ground layer or on the surface, and ensuring a high processing rate. A composition for a texturing process, which is used for texturing a ground layer of an aluminum magnetic disc or a surface of a glass magnetic disc, the composition comprising (A) nano-diamond particles having a specific surface area of 150 m²/g or more, (B) a fatty acid having from 10 to 22 carbon atoms or a fatty acid salt, and (C) an organic amine compound.

### TECHNICAL FIELD

The present invention relates to a composition for a texturing process of forming texturing streaks on a magnetic disc. More specifically, the present invention relates to a composition, for a texturing process, which can realize rapid formation of fine texturing streaks, a small average surface roughness (Ra) of the ground layer after a texturing process, and a high processing speed.

### BACKGROUND ART

The demand for a high recording density of a magnetic disc is increasing and, in order to satisfy this requirement, the distance between the magnetic disc surface and the magnetic head is becoming smaller. To cope with this, the surface of a magnetic disc must as flat as possible, but as the magnetic disc is made flatter, there arises a problem that the magnetic disc after stopping cannot be driven (this is industrially called “adsorption of magnetic head”) and the magnetic disc drive cannot be started. In order to prevent such an “adsorption of magnetic head”, a so-called texturing process was applied, usually to the ground layer (the layer underlying the magnetic layer) of a magnetic disc, until a few years ago.

The texturing process means a process of scrubbing the ground layer surface of a magnetic disc with a polishing tape having attached thereto abrasive grains of a predetermined particle size or with a suspension of abrasive grains, thereby forming fine streaks on the ground layer surface of the magnetic disc. Until a few years ago, the thus-formed texturing streaks had the purpose of preventing the “adhesion of magnetic head” and therefore, satisfied the condition that the size thereof is large to a certain degree but not so large as to cause collision of the flying magnetic head. Furthermore, the texturing streaks must be uniform.

For the formation of such streaks, a slurry prepared by mixing abrasive grains of diamond or alumina in a grinding fluid has been heretofore used as the composition for a texturing process.

However, recently, a bump (generally called a “laser bump”) formed by laser machining has been formed in the inner peripheral part of a magnetic disc and the “adsorption of magnetic head” is prevented by landing the magnetic head on this bump when the magnetic disc is at rest. Therefore, the texturing process is now performed for purposes different from the prevention of “adsorption of magnetic head”.

Currently, the texturing process is performed for the following purposes.
By forming fine texturing streaks, the crystal orientation of grains in the magnetic layer formed on the magnetic disc surface after texturing process is aligned so as to efficiently perform the magnetic recording. At present, for example, about 10 to 30 streaks/μm are formed. Therefore, a texturing streak in a size of about a few μm, as required earlier, is not necessary.
By the fine texturing, “polishing marks” or “polishing scratches” ascribable to the substrate polishing step, which are present before texturing process on the ground layer of an aluminum-made magnetic disc or on the surface of a glass-made magnetic disc, are removed. These “polishing marks” or “polishing scratches” cause an error in reading/writing the recorded information, when using magnetic particles, and hinder an increase in recording density of a magnetic disc, and for the removal of the polishing marks or polishing scratches, a texturing composition usable at a high processing rate is necessary.
The average surface roughness (Ra) of the ground layer after texturing is made small and the flying height of a magnetic head can be minimized.

Japanese Unexamined Patent Publication (Kokai) No. 2003-193041 discloses “a slurry solution comprising a polycrystalline diamond fine powder and a surfactant, wherein the polycrystalline diamond fine powder has an average particle diameter of 0.05 to 5 μm, the polycrystalline diamond fine powder is contained in an amount of 0.01 to 3 wt % based on the slurry solution, and the surfactant is contained in an amount of 0.5 to 30 wt % based on the slurry solution”. Also, Japanese Unexamined Patent Publication (Kokai) No. 06-33042 discloses “a polishing composition for texturing a memory hard disc, which is obtained by dispersing abrasive grains of diamond, silicon carbide or aluminum oxide by using, as a dispersant, a dihydric alcohol having from 2 to 5 carbon atoms, an ethylene glycol polymerization product, or a propylene glycol polymerization product”. Furthermore, Japanese Unexamined Patent Publication (Kokai) No. 08-287456 discloses “a composition for a texturing process of a magnetic disc, comprising a fine particle or powder of diamond or the like, an alkylene glycol monoalkyl ether, and a fatty acid or a metal salt thereof”. However, when using such a slurry solution, as a polishing composition for texturing or a composition for texturing process in these patent publications, the formation of fine texturing streaks, removal of “polishing marks” or “polishing scratches” at a high processing rate, and minimization of an average surface roughness (Ra) of the ground layer after texturing process cannot be achieved at the same time.

In order to enhance the recording density of a magnetic disc, it is necessary that the surface roughness after the texturing process of the ground layer (the layer underlying the magnetic layer) of a magnetic disc is made small to further reduce the flying height of a magnetic head, fine texturing streaks are formed in the disc circumferential direction to efficiently perform the magnetic recording, and the “polishing marks” or “polishing scratches” ascribable to the substrate polishing step, which are present on the ground layer of an aluminum-made magnetic disc or on the surface of a glass-made magnetic disc before texturing process, are removed.

In order to minimize the surface roughness after a texturing process and form fine texturing streaks, a fine particle or powder must be used, but if the particle becomes small, the processing rate usually decreases and the “polishing marks” or “polishing scratches” can hardly be removed by the texturing process.

An object of the present invention is to provide a composition capable of minimizing the average surface roughness (Ra) after texturing of the ground layer of an aluminum magnetic disc or the surface of a glass magnetic disc, forming fine texturing streaks, removing “polishing marks” or “polishing scratches” ascribable to the substrate polishing step, which are present on the ground layer or on the surface of the disc, and ensuring a high processing rate.

### DISCLOSURE OF THE INVENTION

In order to attain the above-described object, the present invention provides a novel composition for a texturing process. The present invention provides the following.

[1] A composition for a texturing process, comprising the following components (A), (B) and (C):

(A) a nano-diamond having a specific surface area of 150 m²/g or more,

(B) a fatty acid having from 10 to 22 carbon atoms or a fatty acid salt, and

(C) an organic amine compound.

[2] The composition for a texturing process as described in [1] above, wherein the nano-diamond is a nano-diamond crystal cluster produced by an oxygen-lacking explosion method.

[3] The composition for a texturing process as described in [2] above, wherein the nano-diamond is a nano-diamond crystal cluster produced by an oxygen-lacking explosion method and is deprived of a surface graphite impurity.

[4] The composition for a texturing process as described in any one of [1] to [3] above, wherein the mean secondary particle diameter of the nano-diamond is from 0.01 to 1 μm.

[5] The composition for a texturing process as described in any one of [1] to [4] above, wherein the nano-diamond content is from 0.001 to 5.0 mass %.

[6] The composition for a texturing process as described in any one of [1] to [5] above, wherein the fatty acid or fatty acid salt is lauric acid, oleic acid or a salt thereof.

[7] The composition for a texturing process as described in any one of [1] to [6] above, wherein the concentration of the fatty acid or fatty acid salt is from 0.01 to 20 mass %.

[8] The composition for a texturing process as described in any one of [1] to [7] above, wherein the concentration of the organic amine compound is from 0.01 to 20 mass %.

[9] The composition for a texturing process as described in any one of [1] to [8] above, which comprises a water-soluble organic solvent or medium.

[10] The composition for a texturing process as described in [9] above, wherein the water-soluble organic solvent or medium is an alkylene glycol monoalkyl ether represented by the formula: R¹O{(CH₂)ₙO}ₘH [wherein R¹ represents a linear or branched alkyl group having a carbon number of 1 to 4, m represents an integer of 1 to 3, and n represents a number of 2 or 3], a polyhydric alcohol having a carbon number of 2 to 5 or its polymerization product, a monohydric alcohol having a carbon number of 2 to 5, or a mixture thereof.

[11] The composition for a texturing process as described in [9] or [10] above, wherein the concentration of the water-soluble organic solvent or medium is 1 mass % or more.

[12] The composition for a texturing process as described in any one of [1] to [11] above, which further comprises a surfactant.

[13] The composition for a texturing process as described in [12] above, wherein the concentration of the surfactant is from 0.01 to 20 mass %.

[14] The composition for a texturing process as described in any one of [1] to [13] above, which is used for texturing a ground layer of an aluminum magnetic disc or a surface of a glass magnetic disc.

[15] A method of texturing a ground layer of an aluminum magnetic disc or a surface of a glass magnetic disc by using the composition for a texturing process described in any one of [1] to [14] above.

### BEST MODE FOR CARRYING OUT THE INVENTION

The synthesis method (oxygen-lacking explosion method) of a nano-diamond was established in the 1960s in former Soviet Union. The impact compression method which is a conventional synthesis method for polycrystalline diamond is a technique of encapsulating a graphite raw material in a metal container, and exploding an explosive outside the metal container to apply an ultrahigh temperature and an ultrahigh pressure, thereby converting the graphite raw material into a diamond, and the primary particle size thereof is generally said to be tens of nm, but the primary particle size fluctuates and individual primary particles are not complete diamonds (single crystals). On the other hand, the oxygen-lacking explosion method is a method of exploding an explosive such as TNT or RDX in an inactive medium to convert the carbon component contained in the explosive itself into diamonds having a primary particle diameter of about 5 nm and being rich in uniformity and here, the individual primary particles are complete single crystal diamonds.

The nano-diamond crystal cluster produced by the oxygen-lacking explosion method comprises nano-diamond primary particles, and the number of nano-diamond primary particles is from less than 10 to several hundreds. The surface of the nano-diamond primary particle is covered with a graphite impurity which is not converted into a diamond, and the nano-diamond crystal cluster is an aggregate difficult to mechanically disassociate, because primary particles are firmly bonded to each other by using this graphite impurity as the medium. Furthermore, the aggregate surface is also covered with the graphite impurity and therefore, the aggregates tend to be further aggregated to form larger tertiary particles. The composition for a texturing process must uniformly form texturing streaks on the magnetic disc surface and, therefore, it is necessary to uniformly disperse abrasive grains in a liquid such as water or organic solvent. Accordingly, the nano-diamond crystal clusters for use in the present invention are sorted by removing the surface graphite impurity through, for example, an acid treatment at a high temperature or a heat treatment in an air atmosphere.

Though not only for such a nano-diamond crystal cluster, the primary particle size of a powder is generally evaluated by a specific surface area (particle surface area per unit weight). The nano-diamond crystal cluster is used in the composition for a texturing process so that the nano-diamond primary particle can act as one cutting blade and a larger number of finer texturing streaks can be formed. Therefore, as the specific surface area is larger, the nano-diamond crystal cluster is more effective. The particle suitably used as an abrasive grain in the composition for texturing process of the present invention is a particle having a specific surface area of 150 m²/g or more, preferably 200 m²/g or more, more preferably 250 m²/g or more.

The composition for texturing process of the present invention may contain an abrasive grain other than the nano-diamond, for example, an artificial abrasive specified in JIS R6111-1987 or an abrasive in accordance therewith having a particle size specified in or according to JIS R6001-1987, an alumina or silicon carbide as a coarse or fine powder of the abrasive grain, an alumina or silicon carbide powder for sintering, a natural or industrially synthesized diamond having a particle size according to JIS R6001-1987, or a diamond fine particle or powder having a special particle size distribution with the maximum particle size being 10 μm or less.

The nano-diamond for use in the composition for texturing process of the present invention preferably has an average secondary particle diameter of 0.01 to 1 μm. If the average secondary particle diameter exceeds 1 μm, the streak formed by the texturing process is too thick, whereas if it is less than 0.01 μm, the cutting force decreases and the “polishing marks” or “polishing scratches” are disadvantageously difficult to remove by the texturing process. The average secondary particle diameter is more preferably from 0.03 to 0.3 μm.

The content of the nano-diamond in the composition for texturing process is preferably from 0.001 to 5 mass %, more preferably from 0.005 to 0.1 mass %. If the nano-diamond content is less than 0.001 mass %, the texturing process efficiency extremely decreases and the “polishing marks” or “polishing scratches” are sometimes hardly removed, whereas even if it exceeds 5 mass %, the texturing process efficiency is not enhanced and, in view of profitability, a nano-diamond content exceeding 5 mass % is not preferred.

Also in the case of using the nano-diamond by mixing it with a fine particle or powder other than diamond, the content is preferably in the above-described range.

Next, as for the fatty acid for use in the composition for texturing process of the present invention, examples thereof include a saturated or mono-, di- or tri-unsaturated fatty acid having a carbon number of 10 to 22, and specific examples thereof include, but are not limited to, capric acid, lauric acid, myristic acid, palmitic acid, stearic acid, behenic acid, oleic acid, linolic acid and linolenic acid.

In the composition for a texturing process of the present invention, one of these fatty acids may be used alone, or two or more thereof may be mixed and used. A fatty acid other than the fatty acid having a carbon number of 10 to 22 may be mixed and used, but for satisfactorily achieving the object of the present invention, it is preferred to use, essentially, only a fatty acid having a carbon number of 10 to 22.

The content of the fatty acid in the composition for texturing process is preferably from 0.01 to 20 mass %. If the fatty acid content is less than 0.01 mass %, the processing rate decreases to make it difficult to thoroughly remove the “polishing marks” or “polishing scratches” by the texturing process in a short time and at the same time, fine texturing streaks may be hardly formed. Even if the fatty acid content exceeds 20 mass %, the effect is not so increased and it is sometimes difficult to prepare the composition of the present invention as a uniform dispersion system. The fatty acid content is more preferably from 0.1 to 3 mass %.

As for the organic amine compound contained in the composition for texturing process of the present invention, specific examples thereof include, but are not limited to:

methylamine (CH₃NH₂),

ethylamine (CH₃CH₂NH₂),

propylamine (CH₃(CH₂)₂NH₂),

isopropylamine ((CH₃)₂CHNH₂),

butylamine (CH₃(CH₂)₃NH₂),

amylamine (CH₃(CH₂)₄NH₂ ),

hexylamine (CH₃(CH₂)₅NH₂),

heptylamine (CH₃(CH₂)₆NH₂),

octylamine (CH₃(CH₂)₇NH₂),

nonylamine (CH₃(CH₂)₈NH₂),

decylamine (CH₃(CH₂)₉NH₂),

undecylamine (CH₃(CH₂)₁₀NH₂),

dodecylamine (CH₃(CH₂)₁₁NH₂),

tridecylamine (CH₃(CH₂)₁₂NH₂),

tetradecylamine (CH₃(CH₂)₁₃NH₂),

pentadecylamine (CH₃(CH₂)₁₄NH₂),

cetylamine (CH₃(CH₂)₁₅NH₂ ),

dimethylamine ((CH₃)₂NH₂),

diethylamine ((C₂H₅)₂NH),

dipropylamine ((n-C₃H₇)₂NH),

diisopropylamine ((i-C₃H₇)₂NH),

dibutylamine ((n-C₄H₉)₂NH),

diamylamine ((n-C₅H₁₁)₂NH),

trimethylamine ((CH₃)₃N),

triethylamine ((C₂H₅)₃N),

tripropylamine ((n-C₃H₇)₃N),

tributylamine ((n-C₄H₉)₃N),

triamylamine ((n-C₅H₁₁)₃N),

allylamine (CH₂═CHCH₂NH₂),

diallylamine ((CH₂═CHCH₂)₂NH),

triallylamine ((CH₂═CHCH₂)₃N),

aniline (C₆H₅NH₂),

methylaniline (C₆H₅NHCH₃),

dimethylaniline (C₆H₅N(CH₃)₂),

ethylaniline (C₆H₅NHC₂H₅),

diethylaniline (C₆H₅N(C₂H₅)₂),

toluidine (C₆H₄(CH₃)(NH₂)),

benzylamine (C₆H₅CH₂NH₂),

dibenzylamine ((C₆H₅CH₂)₂NH),

tribenzylamine ((C₆H₅CH₂)₃N),

diphenylamine ((C₆H₅)₂NH),

triphenylamine ((C₆H₅)₃N),

naphthylamine (C₁₀H₇NH₂),

ethanolamine (HOCH₂CH₂NH₂),

propanolamine (HOCH₂CH₂CH₂NH₂),

butanolamine (HOCH₂CH₂CH₂CH₂NH₂),

diethanolamine ((HOCH₂CH₂)₂NH),

dipropanolamine ((HOCH₂CH₂CH₂)₂NH),

dibutanolamine ((HOCH₂CH₂CH₂CH₂)₂NH),

triethanolamine ((HOCH₂CH₂)₃N),

tripropanolamine ((HOCH₂CH₂CH₂)₃N), and

tributhanolamine ((HOCH₂CH₂CH₂CH₂)₃N).

The content of the organic amine compound contained in the composition for texturing process of the present invention is preferably from 0.01 to 20 mass %. If the organic amine compound content is less than 0.01 mass %, the processing rate sometimes decreases to make it difficult to thoroughly remove the “polishing marks” or “polishing scratches” by the texturing process in a short time, whereas even if the organic amine compound content exceeds 5 mass %, the effect does not increase. The organic amine compound content is more preferably from 0.1 to 3 mass %.

In the composition for a texturing process of the present invention, water is usually used as the solvent or medium, but an organic solvent or medium may also be used.

The composition for texturing process of the present invention may contain water or a water-soluble organic solvent as a sole solvent or medium. The water-soluble organic solvent or medium is preferably an alkylene glycol monoalkyl ether represented by the formula: R¹O{(CH₂)ₙO}ₘH, a polyhydric alcohol having a carbon number of 2 to 5 or its polymerization product, or a monohydric alcohol having a carbon number of 2 to 5.

Specific examples of the alkylene glycol monoalkyl ether include, but are not limited to:

ethylene glycol monomethyl ether (CH₃OCH₂CH₂OH),

ethylene glycol monoethyl ether (C₂H₅OCH₂CH₂OH),

ethylene glycol monobutyl ether (C₄H₉OCH₂CH₂OH),

diethylene glycol monomethyl ether (CH₃(OCH₂CH₂)₂OH),

diethylene glycol monoethyl ether (C₂H₅(OCH₂CH₂)₂OH),

diethylene glycol monobutyl ether (C₄H₉(OCH₂CH₂)₂OH),

propylene glycol monomethyl ether (CH₃OCH₂CH₂CH₂OH),

propylene glycol monoethyl ether (C₂H₅OCH₂CH₂CH₂OH),

propylene glycol monobutyl ether (C₄H₉OCH₂CH₂CH₂OH),

dipropylene glycol monomethyl ether (CH₃(OCH₂CH₂CH₂)₂OH),

dipropylene glycol monoethyl ether (C₂H₅(OCH₂CH₂CH₂)₂OH),

triethylene glycol monomethyl ether (CH₃(OCH₂CH₂CH₂)₃OH),

triethylene glycol monoethyl ether (C₂H₅(OCH₂CH₂CH₂)₃OH), and

tripropylene glycol monomethyl ether (CH₃(OCH₂CH₂CH₂)₃OH).

Specific examples of the polyhydric alcohol having a carbon number of 2 to 5 or its polymerization product for use in the present invention include, but are not limited to:

ethylene glycol (HOCH₂CH₂OH),

propylene glycol (CH₃CH(OH)CH₂OH),

trimethylene glycol (HO(CH₂)₃OH),

1,2-butanediol (HOCH₂CH(OH)CH₂CH₃),

1,3-butanediol (HOCH₂CH₂CH(OH)CH₃),

1,4-butanediol (HO(CH₂)₄OH),

2,3-butanediol (CH₃CH(OH)CH(OH)CH₃),

1,2-pentanediol (HOCH₂CH(OH)CH₂CH₂CH₃),

1,3-pentanediol (HOCH₂CH₂CH(OH)CH₂CH₃),

1,4-pentanediol (HOCH₂CH₂CH₂CH(OH)CH₃),

1,5-pentanediol (HO(CH₂)₅OH),

2,3-pentanediol (CH₃CH(OH)CH(OH)CH₂CH₃),

2,4-pentanediol (CH₃CH(OH)CH₂CH(OH)CH₃),

2-methyl-1,2-propanediol (HOCH₂C(CH₃)(OH)CH₃),

2-methyl-1,3-propanediol (HOCH₂CH(CH₃)CH₂OH),

2-methyl-1,2-butanediol (HOCH₂C(CH₃)(OH)CH₂CH₃),

2-methyl-1,3-butanediol (HOCH₂CH(CH₃)CH(OH)CH₃),

2-methyl-1,4-butanediol (HOCH₂CH(CH₃)CH₂CH₂OH),

2-methyl-2,3-butanediol (CH₃C(CH₃)(OH)CH(OH)CH₃),

2-methyl-2,4-butanediol (CH₃C(CH₃)(OH)CH₃CH₂OH),

2-methyl-3,4-butanediol (CH₃CH(CH₃)CH(OH)CH₂OH),

diethylene glycol (HOCH₂CH₂OCH₂CH₂OH),

triethylene glycol (HOCH₂CH₂OCH₂CH₂OCH₂CH₂OH),

polyethylene glycol (HO(CH₂CH₂O)_{q}CH₂CH₂OH),

dipropylene glycol (HOCH(CH₃)CH₂OCH₂CH(CH₃)OH),

tripropylene glycol (HOCH(CH₃)CH₂OCH₂CH(CH₃)OCH₂CH(CH₃)OH),

polypropylene glycol (HOCH(CH₃)CH₂O(CH₂CH(CH₃)O)_{q}CH₂CH(CH₃)OH), and

glycerin (HOCH₂CH)(OH)CH₂OH).

In these formulae, q is an integer of 4 or more.

In the case of using such an alkylene glycol ether, a polyhydric alcohol having a carbon number of 2 to 5 or its polymerization product, or a monohydric alcohol having a carbon number of 2 to 5 in the composition for texturing process, the content thereof is, as a total amount, preferably 1 mass % or more. If the content of such a solvent is less than 1 mass %, the processing rate may sometimes decrease to make it difficult to thoroughly remove the “polishing marks” or “polishing scratches” by the texturing process in a short time. More preferably, the solvents in the composition all are such water-soluble organic solvents.

The composition for texturing process of the present invention preferably contains a surfactant, because in order to satisfactorily achieve the object of the present invention, the components in the composition for texturing process of the present invention, excluding nano-diamond or other abrasive grains, are preferably formulated into a uniform solution, at least into an emulsion state, and therefore, formulation into a uniform solution or an emulsion is preferably performed by adding a surfactant.

As for the surfactant contained in the composition for texturing process of the present invention, no matter what surfactant is used, that is, an anionic surfactant, a cationic surfactant, an amphoteric surfactant or a nonionic surfactant, a sufficiently high effect is exerted, but a nonionic surfactant is preferred. The amount of the surfactant added is suitably from 0.01 to 20 mass %. If the amount of the surfactant added is less than 0.01 mass %, fine texturing streaks may be difficult to form, whereas if it exceeds 20 mass %, the nano-diamond fine particle or powder slips to decrease the processing rate and therefore, the “polishing marks” or “polishing scratches” may be hardly removed. The amount of the surfactant added is more preferably from 0.1 to 2 mass %.

The composition for texturing process of the present invention is effective in forming homogeneous and fine texturing streaks on a ground layer of an aluminum-made magnetic disc or on a surface of a glass-made magnetic disc, and by virtue of its high processing rate, also effective in removing “polishing marks” or “polishing scratches” ascribable to the substrate polishing step, which are present on the ground layer. In particular, the composition for texturing process of the present invention is excellent in that the processing rate for the glass-made magnetic disc is as high as several times that of a conventional texturing composition using a polycrystalline diamond or a single crystal diamond.

### EXAMPLES

The present invention is described in greater detail below, but the present invention is not limited thereto.

In the following Examples, as shown in Tables 1 and 2, a nano-diamond having a specific surface area of 280 m²/g and a mean secondary particle diameter D₅₀ of 0.12 μm (a nano-diamond crystal cluster produced by the oxygen-lacking explosion method and deprived of the surface graphite impurity), a polycrystalline diamond having a specific surface area of 60 m²/g and a mean secondary particle diameter D₅₀ of 0.12 μm (a polycrystalline diamond produced by the impact compression method and deprived of the surface graphite impurity), or a single crystal diamond having a specific surface area of 40 m²/g and a mean secondary particle diameter D₅₀ of 0.11 μm (a single crystal diamond produced by the static pressure method and deprived of the surface graphite impurity) was used as the diamond. Each diamond was used in an amount shown in the Tables and formulated into a dispersion element by adding 10 mass % of ethylene glycol as a water-soluble organic solvent to improve the dispersibility, with the balance being water, although the ethylene glycol is not essential. In the Tables, the mean secondary particle diameter D₅₀ of the diamond is a cumulative median diameter (median diameter) measured by a laser Doppler particle size distribution meter, UPA, manufactured by Microrolac, Inc. As for the fatty acid, oleic acid, oleate or lauric acid was used at a concentration shown in the Tables. As for the organic amine compound, diethanolamine or triethanolamine was used at a concentration shown in the Tables.

An aluminum substrate for a 95-mm magnetic disc, in which a ground layer was formed by Ni—P plating, was previously subjected to a mirror polishing treatment. This substrate was mounted on a texturing machine (Model EDC-1800A, manufactured by Exclusive Design).

While supplying a slurry comprising each texturing composition having a formulation shown in Tables 1 and 2 from the slurry supply apparatus to the polishing treatment portion of the scrubbing tape, the disc was rotated at a speed of 500 rpm. Here, the slurry was supplied at a rate of 15 ml/min and continuously supplied during the texturing process.

Also, the roller was rotated so that the tape could travel in the same direction as the magnetic disc substrate at a running rate of 5 cm/min. Incidentally, the pressing pressure of the roller at the texturing was 1.0 kg and the texturing process time was 15 seconds.

After processing for 15 seconds, the decrease in weight was very small and the processing rate could hardly be calculated. Therefore, the same texturing process was also performed for 150 seconds.

Furthermore, the same texturing process was performed on a chemically strengthened glass for a 65-mm magnetic disc. The glass substrate was directly textured without forming a ground layer or the like on the glass substrate. The difference from the texturing of aluminum substrate was only the pressure between the tape and the substrate, and the pressure therebetween was 2.0 kg in the case of the glass substrate. Similarly to the aluminum substrate, the texturing process was performed for 15 seconds and for 150 seconds.

The magnetic disc after processing was evaluated by the following methods.

Evaluation Methods:

(1) Number of Texturing Streaks (Number of Streaks):

A viewing range of 1 μm×1 μm on the magnetic disc surface was observed by using an atomic force microscope (SPA-500, manufactured by Seiko Instruments Inc.), and the number of texturing streaks was counted.

(2) Average Surface Roughness (Ra):

A viewing range of 5 μm×5 μm on the magnetic disc surface was observed by using an atomic force microscope (SPA-500, manufactured by Seiko Instruments Inc.), and the average surface roughness was measured.

(3) Processing Rate:

The weight of the magnetic disc was measured before and after the texturing process for 150 seconds, the weight decrease between before and after the processing was determined, divided by the processing time and reduced to a weight decrease per minute, and the obtained value was used as the processing rate.

(4) Polishing Mark:

A viewing range of 5 μm×5 μm on the magnetic disc surface was observed by using an atomic force microscope (SPA-500, manufactured by Seiko Instruments Inc.), and the presence or absence of polishing mark was determined.

TABLE 1

| | Example | | | | | |
|---|---|---|---|---|---|---|
| | 1 | 2 | 3 | 4 | 5 | 6 |
| Substrate | aluminum | aluminum | aluminum | aluminum | aluminum | aluminum |
| Formulation | | | | | | |
| of Composition | | | | | | |
| for Texturing | | | | | | |
| Process | | | | | | |
| Diamond | | | | | | |
| Kind | nano | nano | nano | nano | nano | nano |
| | diamond | diamond | diamond | diamond | diamond | diamond |
| Specific | 280 | 280 | 280 | 280 | 280 | 280 |
| surface | | | | | | |
| area | | | | | | |
| D₅₀ (μm) | 0.12 | 0.12 | 0.12 | 0.12 | 0.12 | 0.12 |
| Concentration | 0.01 mass % | 0.01 mass % | 0.01 mass % | 0.01 mass % | 0.01 mass % | 0.01 mass % |
| Fatty acid | oleic acid, | oleic acid, | oleic acid, | Na oleate, | K oleate, | lauric acid, |
| | 2.5 mass % | 0.5 mass % | 2.5 mass % | 2.5 mass % | 2.5 mass % | 0.5 mass % |
| Organic | diethanolamine, | diethanolamine, | triethanolamine, | triethanolamine, | triethanolamine, | triethanolamine, |
| amine | 5.0 mass % | 1.0 mass % | 5.0 mass % | 5.0 mass % | 5.0 mass % | 1.0 mass % |
| compound | | | | | | |
| Evaluation | | | | | | |
| Results | | | | | | |
| Number of | 58 | 55 | 53 | 55 | 56 | 53 |
| streaks | | | | | | |
| (μm) | | | | | | |
| Ra (Å) | 2.0 | 2.4 | 2.1 | 2.0 | 2.1 | 2.2 |
| Processing | 8.5 | 8.0 | 8.4 | 8.0 | 8.0 | 8.2 |
| rate | | | | | | |
| (mm/min) | | | | | | |
| Polishing | none | none | none | none | none | none |
| mark | | | | | | |

| | Comparative Example | | | |
|---|---|---|---|---|
| | 1 | 2 | 3 | 4 |
| Substrate | aluminum | aluminum | aluminum | aluminum |
| Formulation | | | | |
| of Composition | | | | |
| for Texturing | | | | |
| Process | | | | |
| Diamond | | | | |
| Kind | polycrystalline | polycrystalline | single crystal | single crystal |
| Specific | 60 | 60 | 40 | 40 |
| surface | | | | |
| area | | | | |
| D₅₀ (μm) | 0.12 | 0.12 | 0.11 | 0.11 |
| Concentration | 0.01 mass % | 0.01 mass % | 0.01 mass % | 0.01 mass % |
| Fatty acid | oleic acid, | lauric acid, | oleic acid, | lauric acid, |
| | 2.5 mass % | 0.5 mass % | 2.5 mass % | 0.5 mass % |
| Organic | diethanolamine, | triethanolamine, | diethanolamine, | triethanolamine, |
| amine | 5.0 mass % | 1.0 mass % | 5.0 mass % | 1.0 mass % |
| compound | | | | |
| Evaluation | | | | |
| Results | | | | |
| Number of | 42 | 39 | 38 | 38 |
| streaks | | | | |
| (μm) | | | | |
| Ra (Å) | 4.4 | 4.5 | 4.0 | 4.2 |
| Processing | 8.4 | 8.0 | 8.3 | 8.2 |
| rate | | | | |
| (mm/min) | | | | |
| Polishing | none | none | none | none |
| mark | | | | |

TABLE 2

| | Example | | | | | |
|---|---|---|---|---|---|---|
| | 7 | 8 | 9 | 10 | 11 | 12 |
| Substrate | glass | glass | glass | glass | glass | glass |
| Formulation | | | | | | |
| of Composition | | | | | | |
| for Texturing | | | | | | |
| Process | | | | | | |
| Diamond | | | | | | |
| Kind | nano | nano | nano | nano | nano | nano |
| | diamond | diamond | diamond | diamond | diamond | diamond |
| Specific | 280 | 280 | 280 | 280 | 280 | 280 |
| surface | | | | | | |
| area | | | | | | |
| D₅₀ (μm) | 0.12 | 0.12 | 0.12 | 0.12 | 0.12 | 0.12 |
| Concentration | 0.01 mass % | 0.01 mass % | 0.01 mass % | 0.01 mass % | 0.01 mass % | 0.01 mass % |
| Fatty acid | oleic acid, | oleic acid, | oleic acid, | Na oleate, | K oleate, | lauric acid, |
| | 2.5 mass % | 0.5 mass % | 2.5 mass % | 2.5 mass % | 2.5 mass % | 0.5 mass % |
| Organic | diethanolamine, | diethanolamine, | triethanolamine, | triethanolamine, | triethanolamine, | triethanolamine, |
| amine | 5.0 mass % | 1.0 mass % | 5.0 mass % | 5.0 mass % | 5.0 mass % | 1.0 mass % |
| compound | | | | | | |
| Evaluation | | | | | | |
| Results | | | | | | |
| Number of | 52 | 48 | 48 | 46 | 48 | 49 |
| streaks | | | | | | |
| (μm) | | | | | | |
| Ra (Å) | 3.8 | 3.5 | 3.8 | 3.8 | 3.6 | 3.6 |
| Processing | 30.4 | 26.4 | 28.6 | 27.2 | 27.0 | 27.2 |
| rate | | | | | | |
| (mm/min) | | | | | | |
| Polishing | none | none | none | none | none | none |
| mark | | | | | | |

| | Comparative Example | | | |
|---|---|---|---|---|
| | 5 | 6 | 7 | 8 |
| Substrate | glass | glass | glass | glass |
| Formulation | | | | |
| of Composition | | | | |
| for Texturing | | | | |
| Process | | | | |
| Diamond | | | | |
| Kind | polycrystalline | polycrystalline | single crystal | single crystal |
| Specific | 60 | 60 | 40 | 40 |
| surface | | | | |
| area | | | | |
| D₅₀ (μm) | 0.12 | 0.12 | 0.11 | 0.11 |
| Concentration | 0.01 mass % | 0.01 mass % | 0.01 mass % | 0.01 mass % |
| Fatty acid | oleic acid, | lauric acid, | oleic acid, | lauric acid, |
| | 2.5 mass % | 0.5 mass % | 2.5 mass % | 0.5 mass % |
| Organic | diethanolamine, | triethanolamine, | diethanolamine, | triethanolamine, |
| amine | 5.0 mass % | 1.0 mass % | 5.0 mass % | 1.0 mass % |
| compound | | | | |
| Evaluation | | | | |
| Results | | | | |
| Number of | 45 | 44 | 40 | 39 |
| streaks | | | | |
| (μm) | | | | |
| Ra (Å) | 3.2 | 3.4 | 3.6 | 3.9 |
| Processing | 9.5 | 9.1 | 7.8 | 7.6 |
| rate | | | | |
| (mm/min) | | | | |
| Polishing | remaining | remaining | remaining | remaining |
| mark | | | | |

According to the present invention, the following effects are provided.

The nano-diamond comprises a nano-diamond crystal cluster with the primary particle being a complete single crystal having a very small particle size of, for example, about 5 nm and when this is used in the composition for texturing process, the single crystal diamond primary particle having high hardness acts as an effective cutting blade at the texturing process face, so that the density of texturing streaks can be increased as compared with the processing with a conventional texturing composition comprising a polycrystalline diamond or a single crystal diamond. As a result, anisotropic output on the magnetic film surface can be more successfully obtained and the recording density can be elevated.

By virtue of the small primary particle size, the number of effective cutting blades is markedly increased, so that a high processing rate can be obtained and the “polishing marks” or “polishing scratches” ascribable to the polishing step of the magnetic disc can be efficiently removed. Therefore, an error in reading/writing the recording with use of magnetic particles, which is generated due to “polishing marks” or “polishing scratches”, can be greatly decreased and the recording density can be elevated.

Furthermore, by virtue of the high processing rate, the texturing process time can be shortened and the productivity of the magnetic disc can be remarkably enhanced.

### INDUSTRIAL APPLICABILITY

The composition for a texturing process provided by the present invention is useful for texturing a magnetic disc.

1. A composition for a texturing process, comprising the following components (A), (B) and (C):
(A) a nano-diamond having a specific surface area of 150 m²/g or more,
(B) a fatty acid having from 10 to 22 carbon atoms or a fatty acid salt, and
(C) an organic amine compound.

2. The composition for a texturing process as claimed in claim 1, wherein the nano-diamond is a nano-diamond crystal cluster produced by an oxygen-lacking explosion method.

3. The composition for a texturing process as claimed in claim 2, wherein the nano-diamond is a nano-diamond crystal cluster produced by an oxygen-lacking explosion method and deprived of a surface graphite impurity.

4. The composition for a texturing process as claimed in claim 1, wherein the mean secondary particle diameter of the nano-diamond is from 0.01 to 1 m.

5. The composition for a texturing process as claimed in claim 1, wherein the nano-diamond content is from 0.001 to 5.0 mass %.

6. The composition for a texturing process as claimed in claim 1, wherein the fatty acid or fatty acid salt is lauric acid, oleic acid or a salt thereof.

7. The composition for a texturing process as claimed in claim 1, wherein the concentration of the fatty acid or fatty acid salt is from 0.01 to 20 mass %.

8. The composition for a texturing process as claimed in claim 1, wherein the concentration of the organic amine compound is from 0.01 to 20 mass %.

9. The composition for a texturing process as claimed in claim 1, which comprises a water-soluble organic solvent or medium.

10. The composition for a texturing process as claimed in claim 9, wherein the water-soluble organic solvent or medium is an alkylene glycol monoalkyl ether represented by the formula: R¹O{(CH₂)ₙO}ₘH [wherein R¹ represents a linear or branched alkyl group having a carbon number of 1 to 4, m represents an integer of 1 to 3, and n represents a number of 2 or 3], a polyhydric alcohol having a carbon number of 2 to 5 or its polymerization product, a monohydric alcohol having a carbon number of 2 to 5, or a mixture thereof.

11. The composition for a texturing process as claimed in claim 9, wherein the concentration of the water-soluble organic solvent or medium is 1 mass % or more.

12. The composition for a texturing process as claimed in claim 1, which further comprises a surfactant.

13. The composition for a texturing process as claimed in claim 12, wherein the concentration of the surfactant is from 0.01 to 20 mass %.

14. The composition for a texturing process as claimed in claim 1, which is used for texturing a ground layer of an aluminum-made magnetic disc or a surface of a glass-made magnetic disc.

15. A method for texturing a ground layer of an aluminum magnetic disc or a surface of a glass magnetic disc by using the composition for a texturing process claimed in claim 1.
